(19) United States
(12) Patent Application Publication
(10) Pub. No.: US 2018/0130077 A1
(43) Pub. Date: May 10, 2018

(54) AUTOMATED SELECTION AND PROCESSING OF FINANCIAL MODELS

(71) Applicant: Fractal Industries, Inc., Reston, VA (US)

(72) Inventors: Jason Crabtree, Vienna, VA (US); Hao Pan, Reston, VA (US); Andrew Sellers, Colorado Springs, CO (US); Roman Tejada, Vienna, VA (US); Alexander Temerev, Geneva (CH)

(21) Appl. No.: 15/673,368

(22) Filed: Aug. 9, 2017

Related U.S. Application Data
(63) Continuation-in-part of application No. 15/376,657, filed on Dec. 13, 2016.
Application No. 15/376,657 is a continuation-in-part of application No. 15/237,625, filed on Aug. 15, 2016.
Application No. 15/237,625 is a continuation-in-part of application No. 15/206,195, filed on Jul. 8, 2016.
Application No. 15/206,195 is a continuation-in-part of application No. 15/186,453, filed on Jun. 18, 2016.
Application No. 15/186,453 is a continuation-in-part of application No. 15/166,158, filed on May 26, 2016.
Application No. 15/166,158 is a continuation-in-part of application No. 15/141,752, filed on Apr. 28, 2016.
Application No. 15/141,752 is a continuation-in-part of application No. 15/091,563, filed on Apr. 5, 2016.
Application No. 15/091,563 is a continuation-in-part of application No. 14/986,536, filed on Dec. 31, 2015.
Application No. 14/986,536 is a continuation-in-part of application No. 14/925,974, filed on Oct. 28, 2015.

(51) Int. Cl. G06Q 30/02; G06Q 10/06

(52) U.S. Cl. CPC G06Q 30/0205; G06F 17/30864; G06Q 30/0201; G06Q 10/067

(57) ABSTRACT

A system for automated selection and processing of financial models. A time series data retrieval and storage server observes and records a first dataset from external sources, and retrieves a second dataset comprising previously observed, processed, and stored data. A directed computational graph analysis module retrieves gathered data and comparatively analyzes the first dataset against the second dataset to determine an optimal model to use for predictive simulation. An automated planning service module retrieves analysis results and performs predictive simulation using the previous determined optimal model with the first dataset as input.

### CROSS-REFERENCE TO RELATED APPLICATIONS

This application is a continuation-in-part of U.S. patent application Ser. No. 15/376,657 titled “QUANTIFICATION FOR INVESTMENT VEHICLE MANAGEMENT EMPLOYING AN ADVANCED DECISION PLATFORM”, and filed on Dec. 13, 2016, which is a continuation-in-part of U.S. patent application Ser. No. 15/237,625, titled “DETECTION MITIGATION AND REMEDIATION OF CYBERATTACKS0 EMPLOYING AN ADVANCED CYBER-DECISION PLATFORM”, and filed on Aug. 15, 2016, which is a continuation-in-part of U.S. patent application Ser. No. 15/206,195, titled “ACCURATE AND DETAILED MODELING OF SYSTEMS WITH LARGE COMPLEX 10 DATASETS USING A DISTRIBUTED SIMULATION ENGINE”, and filed on Jul. 8, 2016, which is continuation-in-part of U.S. patent application Ser. No. 15/186,453, titled “SYSTEM FOR AUTOMATED CAPTURE AND ANALYSIS OF BUSINESS INFORMATION FOR RELIABLE BUSINESS VENTURE OUTCOME PREDICTION” and filed on Jun. 18, 2016, which is a continuation-in-part of U.S. patent application Ser. No. 15/166,158, titled 15 “SYSTEM FOR AUTOMATED CAPTURE AND ANALYSIS OF BUSINESS INFORMATION FOR SECURITY AND CLIENT-FACING INFRASTRUCTURE RELIABILITY”, and filed on May 26, 2016, which is a continuation-in-part of U.S. patent application Ser. No. 15/141,752, titled “SYSTEM FOR FULLY INTEGRATED CAPTURE, AND ANALYSIS OF BUSINESS INFORMATION RESULTING IN PREDICTIVE DECISION MAKING AND 20 SIMULATION, and filed on Apr. 28, 2016, which is a continuation-in-part of U.S. patent application Ser. No. 14/925,974, titled “RAPID PREDICTIVE ANALYSIS OF VERY LARGE DATA SETS USING THE DISTRIBUTED COMPUTATIONAL GRAPH” and filed on Oct. 28, 2015, and is also a continuation-in-part of U.S. patent application Ser. No. 14/986,536, titled “DISTRIBUTED SYSTEM FOR LARGE VOLUME DEEP WEB DATA 25 EXTRACTION”, and filed on Dec. 31, 2015, and is also a continuation-in-part of U.S. patent application Ser. No. 15/091,563, titled “SYSTEM FOR CAPTURE, ANALYSIS AND STORAGE OF TIME SERIES DATA FROM SENSORS WITH HETEROGENEOUS REPORT INTERVAL PROFILES”, and filed on Apr. 5, 2016, the entire specification of each of which is incorporated herein by reference in its entirety.

### BACKGROUND OF THE INVENTION

### Field of the Invention

The disclosure relates to the field of finance, particularly to the selection of optimal financial models for market prediction.

### Discussion of the State of the Art

In the field of finance, vast amounts of data may be generated, ranging from fluctuations of stocks or currencies, general pricing information, news regarding a company or country's economy, etc. The data may then be inspected by experts to generate a prediction regarding various effects on financial markets, and currencies. Mathematical models are often used in the prediction process, and the repertoire of models available to an analyst are plentiful. However, the process of choosing a model to use, along with the process of gathering data, analyzing the data, and running calculations, whether through specialized software or using a spreadsheet, may prove to be time consuming. There may also be a time delay between when new data becomes available, and when the data is finally gathered and processed. Calculations may also be prone to human-error.

What is needed is a system in which the tedious tasks may be automated. Such a system may be able to autonomously and continuously observe and record new events, update previously stored information, gather new information from sources like news outlets, as well as analyzing the data to pick optimal models to use for pricing analysis and prediction.

### SUMMARY OF THE INVENTION

Accordingly, the inventor has developed a system for systematically selecting and processing financial models. In a typical embodiment, the system for systematically selecting and processing financial models observes and records financial data, and events. The data may be analyzed and processed by a business operating system to determine such metrics as similarity to previously analyzed stored in memory, model bias, bias characterization, and optimal model with available venues for a user to provide input for additional consideration by the system. The system may also provide predictions, as well as provide trading advice based on results of model analysis.

According to a preferred embodiment, a system for automated selection and processing of financial models is provided, comprising a time series data retrieval and storage server comprising a memory, a processor, and a plurality of programming instructions stored in the memory thereof and operable on the processor thereof, wherein the programmable instructions, when operating on the processor, cause the processor to observe and record a first dataset from a plurality of external sources, and retrieve a second dataset comprising previously observed, processed, and stored data; a directed computational graph analysis module comprising a memory, a processor, and a plurality of programming instructions stored in the memory thereof and operable on the processor thereof, wherein the programmable instructions, when operating on the processor, cause the processor to retrieve the first and second datasets from the time series data retrieval and storage server, and comparatively analyze the first dataset against second dataset to determine an optimal model to use for predictive simulation; and an automated planning service module comprising a memory, a processor, and a plurality of programming instructions stored in the memory thereof and operable on the processor thereof, wherein the programmable instructions, when operating on the processor, cause the processor to retrieve analysis results from the directed computational graph analysis module, and perform predictive simulation using the previous determined optimal model with the first dataset as input.

According to another embodiment of the system, at least a portion of the data is analyzed using dynamic time warping to determine the optimal model. According to another embodiment, at least a portion of the data analyzed is the phase, magnitude, and topology. According to another embodiment, at least a portion of the data gathered and processed comprises financial market data. According to another embodiment, least a portion of the data gathered and processed comprises financial news. According to another embodiment, at least a portion of the data is processed using clustering analysis. According to another embodiment, at least a portion of the data processed is user input during the processing of data. According to another embodiment, analysis results are further processed and analyzed to generate advisable next steps at a user.

According to another aspect of the invention, method for automated selection and processing of financial models is provided, comprising the steps of: (a) observing and recording a first dataset from a plurality of external sources using a time series data retrieval and storage server; (b) retrieving a second dataset comprising previously observed, processed, and stored data using the time series data retrieval and storage server; (c) retrieving the first and second datasets from the time series data retrieval and storage server using a directed computational graph analysis module; (d) comparatively analyzing the first dataset against second dataset to determine an optimal model to use for predictive simulation using the directed computational graph analysis module; (e) retrieving analysis results from the directed computational graph analysis module using an automated planning service module; and (d) performing predictive simulation using the previous determined optimal model with the first dataset as input using the automated planning service module.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of a business operating system according to an embodiment of the invention.

FIG. 2A is a diagram of modules of the business operating system configured specifically for use in investment vehicle management according to an embodiment of the invention.

FIG. 2B is an extension of the system shown in FIG. 2A showing directed computational graph module furthered configured for financial data analysis using its associated transformer service module according to various embodiments of the invention.

FIG. 2C is an extension of the system shown in FIG. 2A showing connector module furthered configured for financial data analysis according to various embodiments of the invention.

FIG. 3 is a flow diagram of an exemplary function of the business operating system in the calculation of future investment performance.

FIG. 4 is a diagram of an indexed global tile module as per one embodiment of the invention.

FIG. 5 is a flow diagram illustrating a method for characterizing model bias according to various embodiments of the invention.

FIG. 6 is a flow diagram illustrating a method for determining a model bias score according to various embodiments of the invention.

FIG. 7 is a flow diagram illustrating a method for processing previously stored data to be used in similarity testing according to various embodiments of the invention.

FIG. 8 is a flow diagram illustrating a method for systematically determining an appropriate model to use for newly observed data using model bias scoring, and model bias characterization with a business operating system according to various embodiments of the invention.

FIG. 9 is a block diagram illustrating an exemplary hardware architecture of a computing device used in various embodiments of the invention.

FIG. 10 is a block diagram illustrating an exemplary logical architecture for a client device, according to various embodiments of the invention.

FIG. 11 is a block diagram illustrating an exemplary architectural arrangement of clients, servers, and external services, according to various embodiments of the invention.

FIG. 12 is another block diagram illustrating an exemplary hardware architecture of a computing device used in various embodiments of the invention.

### DETAILED DESCRIPTION

The inventor has conceived, and reduced to practice, a system for automated selection and processing of financial models.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

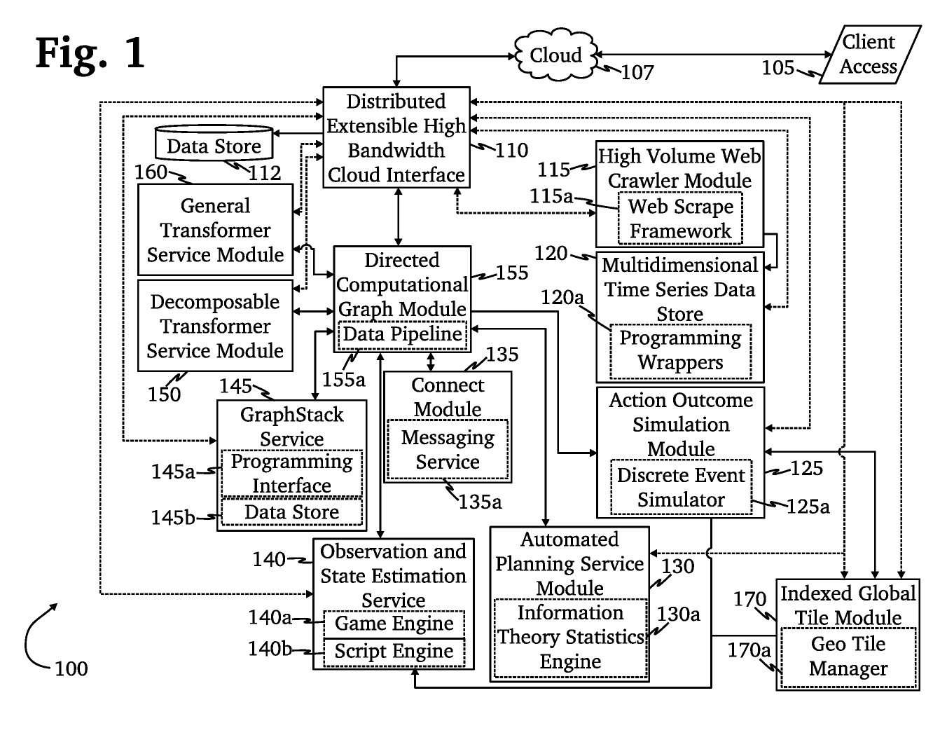

FIG. 1 is a diagram of an exemplary architecture of a business operating system 100 according to an embodiment of the invention. Client access to system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information and a data store 112 such as, but not limited to MONGODB™, COUCHDB™, CASSANDRA™ or REDIS™ depending on the embodiment. Much of the business data analyzed by the system both from sources within the confines of the client business, and from cloud based sources 107, public or proprietary such as, but not limited to: subscribed business field specific data services, external remote sensors, subscribed satellite image and data feeds and web sites of interest to business operations both general and field specific, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and a graph stack service 145. Directed computational graph module 155 retrieves one or more streams of data from a plurality of sources, which includes, but is not limited to, a plurality of physical sensors, network service providers, web based questionnaires and surveys, monitoring of electronic infrastructure, crowd sourcing campaigns, and human input device information. Within directed computational graph module 155, data may be split into two identical streams in a specialized pre-programmed data pipeline 155a, wherein one sub-stream may be sent for batch processing and storage while the other sub-stream may be reformatted for transformation pipeline analysis. The data may be then transferred to a general transformer service module 160 for linear data transformation as part of analysis or the decomposable transformer service module 150 for branching or iterative transformations that are part of analysis. Directed computational graph module 155 represents all data as directed graphs where the transformations are nodes and the result messages between transformations edges of the graph. High-volume web crawling module 115 may use multiple server hosted preprogrammed web spiders which, while autonomously configured, may be deployed within a web scraping framework 115a of which SCRAPY™ is an example, to identify and retrieve data of interest from web based sources that are not well tagged by conventional web crawling technology. Multiple dimension time series data store module 120 may receive streaming data from a large plurality of sensors that may be of several different types. Multiple dimension time series data store module 120 may also store any time series data encountered by system 100 such as, but not limited to, environmental factors at insured client infrastructure sites, component sensor readings and system logs of some or all insured client equipment, weather and catastrophic event reports for regions an insured client occupies, political communiques and/or news from regions hosting insured client infrastructure and network service information captures (such as, but not limited to, news, capital funding opportunities and financial feeds, and sales, market condition), and service related customer data. Multiple dimension time series data store module 120 may accommodate irregular and high-volume surges by dynamically allotting network bandwidth and server processing channels to process the incoming data. Inclusion of programming wrappers 120a for languages—examples of which may include, but are not limited to, C++, PERL, PYTHON, and ERLANG™—allows sophisticated programming logic to be added to default functions of multidimensional time series database 120 without intimate knowledge of the core programming, greatly extending breadth of function. Data retrieved by multidimensional time series database 120 and high-volume web crawling module 115 may be further analyzed and transformed into task-optimized results by directed computational graph 155 and associated general transformer service 160 and decomposable transformer service 150 modules. Alternately, data from the multidimensional time series database and high-volume web crawling modules may be sent, often with scripted cuing information determining important vertices 145a, to graph stack service module 145 which, employing standardized protocols for converting streams of information into graph representations of that data, for example open graph internet technology (although the invention is not reliant on any one standard). Through the steps, graph stack service module 145 represents data in graphical form influenced by any pre-determined scripted modifications 145a and stores it in a graph-based data store 145b such as GIRAPH™ or a key-value pair type data store REDIS™, or RIAK™, among others, any of which are suitable for storing graph-based information.

Results of the transformative analysis process may then be combined with further client directives, additional business rules and practices relevant to the analysis and situational information external to the data already available in automated planning service module 130, which also runs powerful information theory-based predictive statistics functions and machine learning algorithms 130a to allow future trends and outcomes to be rapidly forecast based upon the current system derived results and choosing each a plurality of possible business decisions. Then, using all or most available data, automated planning service module 130 may propose business decisions most likely to result in favorable business outcomes with a usably high level of certainty. Closely related to the automated planning service module 130 in the use of system-derived results in conjunction with possible externally supplied additional information in the assistance of end user business decision making, action outcome simulation module 125 with a discrete event simulator programming module 125a coupled with an end user-facing observation and state estimation service 140, which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

A significant proportion of the data that is retrieved and transformed by the business operating system, both in real world analyses and as predictive simulations that build upon intelligent extrapolations of real world data, may include a geospatial component. The indexed global tile module 170 and its associated geo tile manager 170a may manage externally available, standardized geospatial tiles and may enable other components of the business operating system, through programming methods, to access and manipulate meta-information associated with geospatial tiles and stored by the system. The business operating system may manipulate this component over the time frame of an analysis and potentially beyond such that, in addition to other discriminators, the data is also tagged, or indexed, with their coordinates of origin on the globe. This may allow the system to better integrate and store analysis specific information with all available information within the same geographical region. Such ability makes possible not only another layer of transformative capability, but may greatly augment presentation of data by anchoring to geographic images including satellite imagery and superimposed maps both during presentation of real world data and simulation runs.

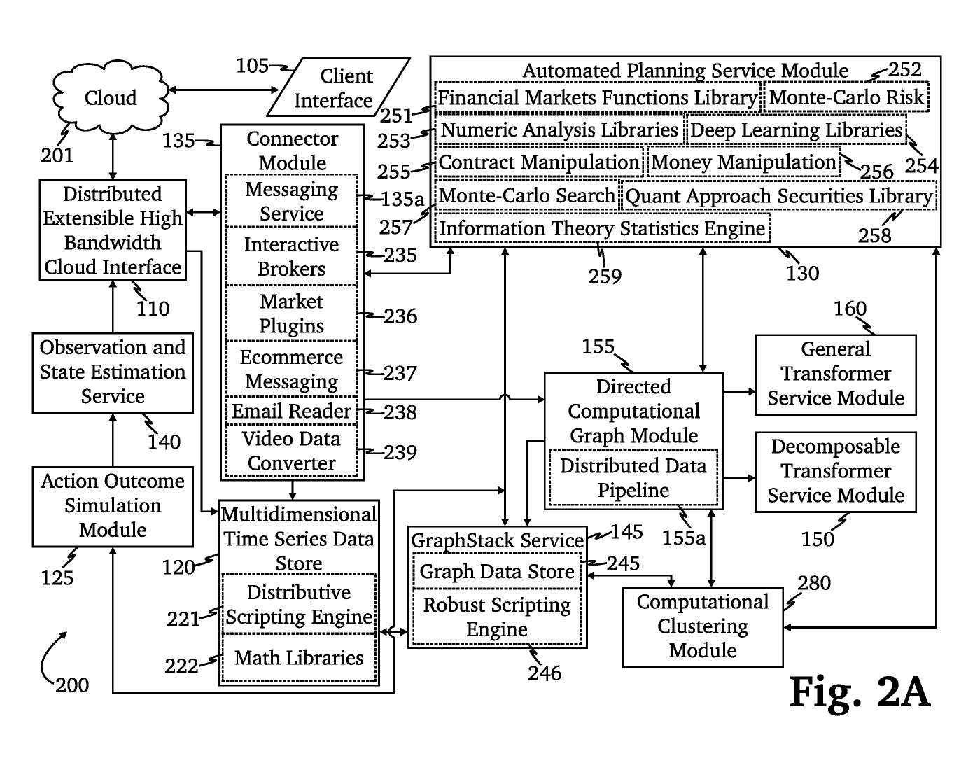

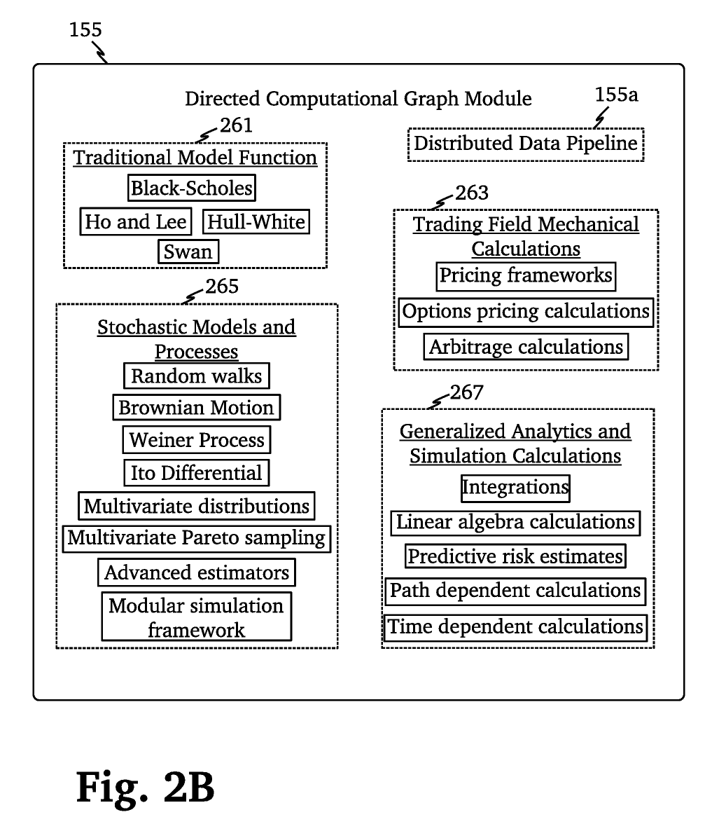

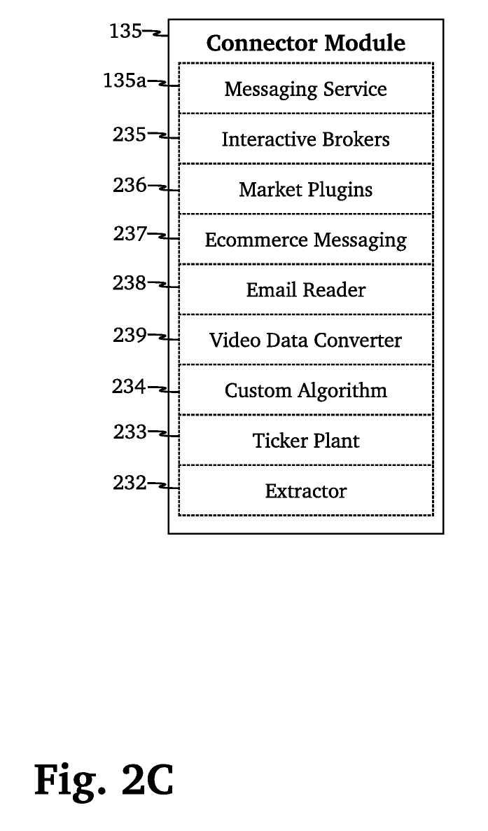

FIG. 2A is a diagram of modules of the business operating system configured specifically for use in investment vehicle management according to an embodiment of the invention 200. The business operating system 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations to produce investment predictions. Much of the trading specific programming functions are added to the automated planning service module 130 of the modified business operating system 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services, either public or private, through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the business operating system may also perform significant analytical transformations on trade related data. These may include the multidimensional time series data store 120 with its robust scripting features which may include a distributive friendly, fault-tolerant, real-time, continuous run prioritizing programming platform 221 such as, but not limited to, Erlang/OTP, and a compatible but comprehensive and proven math library functions 222, for example C⁺⁺ math libraries, data formalization and ability to capture time series data including irregularly transmitted burst data; the GraphStack service 145 which transforms data into graphical representations for relational analysis and may use packages for graph format data storage 245, such as Titan or the like, and a robust scripting engine 246, which may be a highly accessible programming interface, an example of which may be Akka/Spray, although other, similar, combinations may equally serve the same purpose in this role to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results may be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized, and intricate transformations such as those that may be associated with deep machine learning, first disclosed in ¶067 of co-pending application Ser. No. 14/925,974, predictive analytics and predictive simulations, distribution of computer resources to a plurality of systems may be routinely required to accomplish these tasks due to the volume of data being handled and acted upon. The business operating system employs a distributed architecture that is highly extensible to meet these needs. Additionally, a number of the tasks carried out by the system may be extremely processor intensive. For these processor-intensive tasks the highly integrated process of hardware clustering of systems, possibly of a specific hardware architecture particularly suited to the calculations inherent in the task, may be desirable, if not required, for timely completion. The system includes a computational clustering module 280 to allow the configuration and management of such clusters during application of the business operating system. While the computational clustering module is illustrated in FIG. 2A as directly connected to specific co-modules of the business operating system, these connections, while logical, are for ease of illustration and those skilled in the art may realize that the functions attributed to specific modules of an embodiment may require clustered computing under one use case and not under others. Similarly, the functions designated to a clustered configuration may be role, if not run, dictated. Further, not all use cases or data runs may use clustering.

Additionally, within the large amounts of data gathered and stored, a substantial amount of the stored data may require frequent updating, for instance, stock symbols and corresponding prices, which may prove to be time-consuming. Business operating system 100 may be configured to autonomously and continuously gather data in a background process, for example, using subroutines of connector module 135, such as email reader 238 or market plugins 236; using subroutines of automated planning service module 130, such as financial markets function library 251; using web crawler module 115 to scour news financial news sites; or using time series data store 120 to receive updated stock pricing at regular intervals. The data may then be processed and used by business operating system 100 to improve and update stored data. These operations may include, but not limited to, semantic extraction from corporate news and macro data; cross-linking to GraphStack entries; and automated time series feature engineering through the use of libraries like TSFresh, or using dimensionality reduction. Additionally, the high-bandwidth capabilities of business operating system 100 enables low-latency links to market data providers and venues to provide a nearly real-time channel to market data for the user using a ticker plant module 233 shown in FIG. 2C. The data that may be provided by market data providers and venues may include, but is not limited to, stock symbols and pricing, order book information, fill reports, news, and fundamentals. Business operating system 100 may also be configured to perform error-checking and self-heal the data as it is received.

In fields like finance, risks may be plentiful, and may come from many diverse sources. The source of risks may include, but is not limited to, systemic risks, for example collapse of a stock market; government risks, for example new regulations or legislative activity; and general risk, for example operational risks, disasters, personnel risk, and legal risks. With business operating system 100 configured to analyze market data, and other external data sourced from, for instance, financial news outlets or expert opinion, and analyzed using functions such as Monte Carlo risk routines 252, business operating system 100 may be able to take into consideration the various risks, and more accurately determine their adverse effects on financial holdings. This may enable a user to stay on top of potential downward trends, and offer them the opportunity to take action in the face of new risk development.

FIG. 2B is an extension of the system shown in FIG. 2A showing directed computational graph module 155 furthered configured to perform financial data analysis using its associated transformer service module according to various embodiments of the invention. Specially configured directed computational graph module 155 may comprise routines for traditional model functions 261, trading field mechanical calculations 263, stochastic models and processes 265, and generalized analytics and simulation calculations 267. Traditional model functions 261 are operations involving standard models commonly used in the art. Examples of models used in traditional model functions 261 may include Black-Scholes, Ho and Lee, Hull-White, and Swan diagram modeling.

Trading field mechanical calculations 263 are operations involving standard pricing related calculations, for example, calculations involving pricing frames, options pricing calculations, and arbitrage calculations.

Stochastic models and processes 265 are operations relating to multivariate operations used in the art, for example, random walks process, Brownian motion, Weiner process, Ito differential, multivariate distributions (i.e. Markov chain Monte Carlo), multivariate Pareto sampling, and advanced estimators.

Generalized analytics and simulation calculations 267 are operations involving general mathematics, for example integrations, linear algebra calculations, predictive risk estimates, path dependent calculations, and time dependent calculations.

FIG. 2C is an extended connector module as illustrated in FIG. 2A. In addition to functions and features found in FIG. 2A, connector module 135 may also have a custom algorithm module 234, a ticker plant module 233, and an extractor module 232. Custom algorithm module 234 provides an interface to enable a user to add custom, user-created trading algorithms. The algorithms may utilize a rules-based system which is commonly found in business process modelling. For example, on a very basic level, a user may create algorithms to execute a particular trade when certain conditions are met, for instance when a certain order book spread occurs, or a stock arrives at a certain price. Ticker plant module 233, provides a low-latency, practically real-time link to market data sources that may provide information, such as pricing pertaining to stocks, bonds, commodities, futures, options, and currencies. Extractor module 232 may be used by business operating system 100 to intelligently extract relevant information from sources such as current events, news, and sentiment and may be configured to extract information based on region or sector. The extracted information may be cleansed and processed for use in other modules of business operating system 100.

It should be understood that the routines and subroutines illustrated in in FIGS. 2B and 2C are not intended to be comprehensive, and should instead be seen as an example of operations that may be configured for directed computational graph module 155 with the associated transformer modules, and connector module 135. The operations listed are also not required to all be run in a single process, and may be selected and executed piecemeal in a modular manner depending on the requirements of the user.

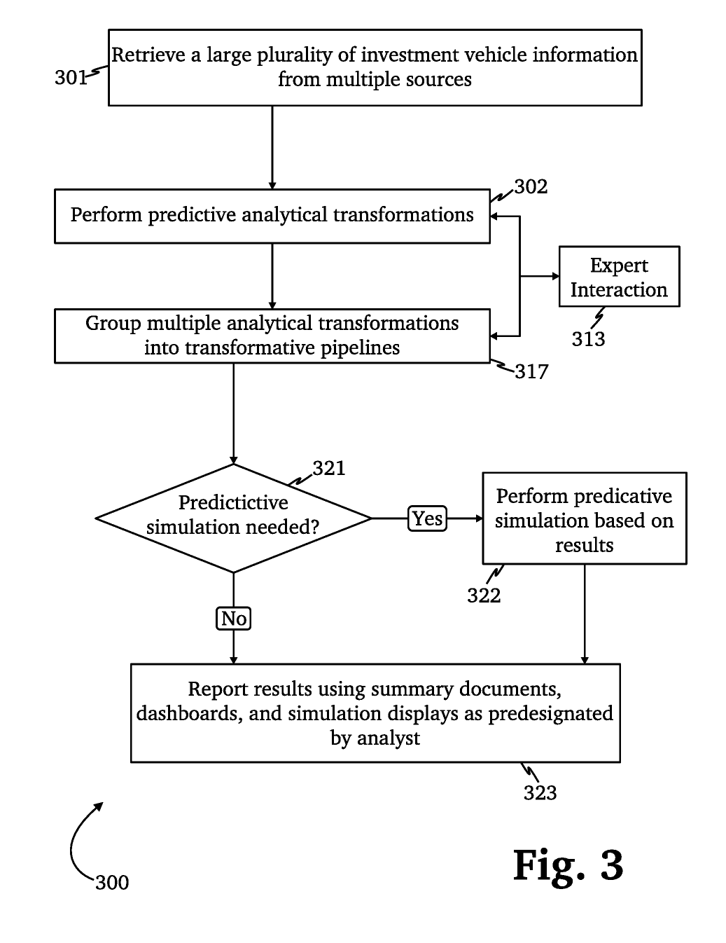

FIG. 3 is a flow diagram 300 of an exemplary function of the business operating system in the calculation of future investment performance. New investment opportunities are continuously arising and the ability to profitably participate in these new opportunities is of great importance. An embodiment of the invention 100 programmed to analyze investment trading related data and recommend investment vehicles may greatly assist in development of a profitable plan in potential new markets. Retrieval or input of any prospective new market related data from a plurality of both public and available private or proprietary sources acts to seed the process in step 301, specific modules of the system such as connector module 135 with its programmable messaging service 135a, high volume web crawler 115, and directed computational graph module 155, among possible others act to scrub, format, and normalize data from many sources for use. Such data is then subjected to predictive analytical transformations in step 302, which may include traditional model functions such as, but not limited, to Black-Scholes, Ho and Lee, and Hull-White; trading field mechanical calculations such as, but not limited to, pricing frameworks, options pricing calculations, and arbitrage calculations; and more generalized analytics and simulation calculations such as, but not limited to, integrations, linear algebra calculations, predictive risk estimations, stochastic processes functions, path dependent calculations, and time dependent calculations, all of which may serve to create the most accurate assessment of investment fitness given a particular vehicle and the large volume of data that surrounds and affects its current and predictable future performance. During the calculation process, there may be information added to the body of data by the input interaction of an analyst or other human expert party in step 313 to increase the accuracy of the interim calculated projections as one of the designed functions of the business operating system is to retrieve, cleanse and aggregate the overwhelming volume of data connected to a field of decision allowing human users to concentrate on the creative and higher order aspects of that data.

Many of the calculations above may be carried out as part of linear, branched or recursive pipelines using either general transformer service module 160, which may be specialized to rapidly perform linear transformation pipelines, and decomposable transformer service module 150 for branching and recursive pipelines in step 317. Again, expert interaction may be added at this point in the form of added data or modified programmed functions. At step 321, these results may then be formatted for direct display, formatted for further analysis by third party solutions or directly stored for later analysis, possibly in combination with other data in step 323, if no predictive simulation is needed. Otherwise, accumulated data may be used in the creation of predictive simulations prior to display of that simulated information in the desired format in step 322.

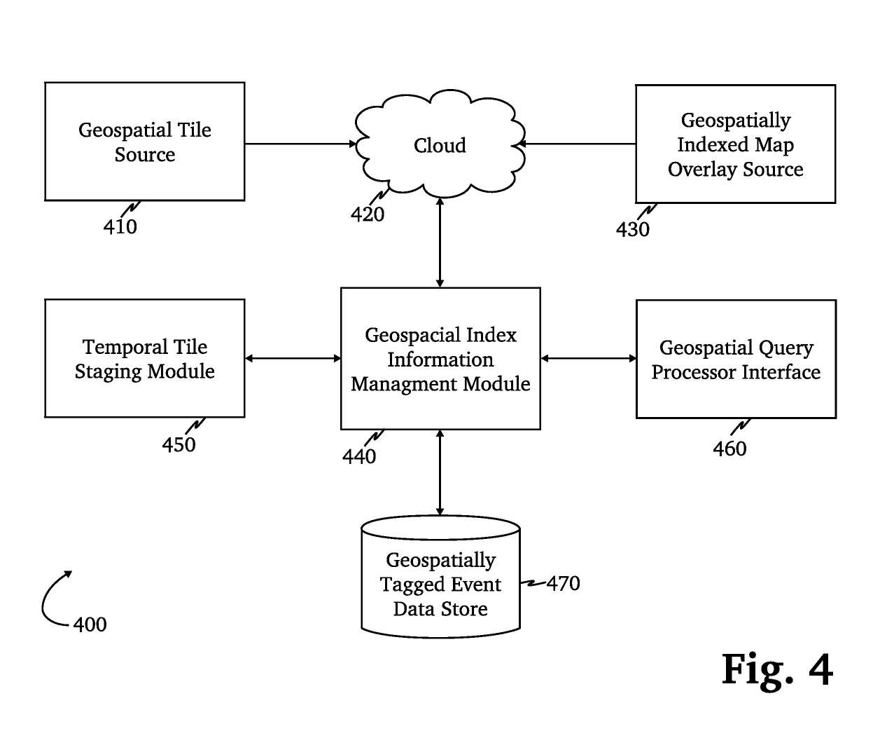

FIG. 4 is a diagram of an indexed global tile module 400 as per one embodiment of the invention. A significant amount of the data transformed and simulated by the business operating system has an important geospatial component. Indexed global tile module 170 allows both for the geo-tagging storage of data as retrieved by the system as a whole and for the manipulation and display of data using its geological data to augment the data's usefulness in transformation, for example creating ties between two independently acquired data points to more fully explain a phenomenon; or in the display of real world, or simulated results in their correct geospatial context for greatly increased visual comprehension and memorability. Indexed global tile module 170 may consist of a geospatial index information management module which retrieves indexed geospatial tiles from a cloud-based source 410, 420 known to those skilled in the art, and may also retrieve available geospatially indexed map overlays from a geospatially indexed map overlay source 430 known to those skilled in the art. Tiles and their overlays, once retrieved, represent large amounts of potentially reusable data and are therefore stored for a pre-determined amount of time to allow rapid recall during one or more analyses on a temporal staging model 450. To be useful, it may be required that both the transformative modules of the business operating system, such as, but not limited to directed computational graph module 155, automated planning service module 130, action outcome simulation module 125, and observational and state estimation service 140 be capable of both accessing and manipulating the retrieved tiles and overlays. A geospatial query processor interface 460 serves as a program interface between these system modules and geospatial index information management module 440 which fulfills the resource requests through specialized direct tile manipulation protocols, which for simplistic example may include “get tile xxx,” “zoom,” “rotate,” “crop,” “shape,” “stitch,” and “highlight” just to name a very few options known to those skilled in the field. During analysis, the geospatial index information management module may control the assignment of geospatial data and the running transforming functions to one or more swimlanes to expedite timely completion and correct storage of the resultant data with associated geotags. The transformed tiles with all associated transformation tagging may be stored in a geospatially tagged event data store 470 for future review. Alternatively, just the geotagged transformation data or geotagged tile views may be stored for future retrieval of the actual tile and review depending on the need and circumstance. There may also be occasions where time series data from specific geographical locations are stored in multidimensional time series data store 120 with geo-tags provided by geospatial index information management module 440.

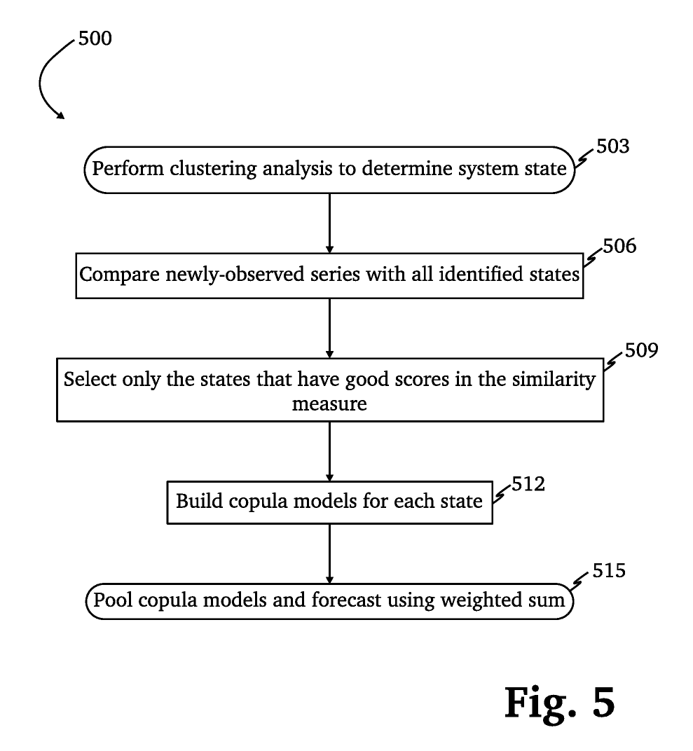

FIG. 5 is a flow diagram illustrating a method 500 for characterizing model bias according to various embodiments of the invention. In step 503, clustering analysis, such as K-means clustering analysis, is performed on stored time series data, such as stock return data, to determine a system state. A system state may be seen as a classification for each cluster. In step 506, the state for newly-observed series are compared to previously identified and observed states, taking particular notice in states that bear a high similarity score to the state consisting of the newly-observed time series data. In step 509, the states with good similarity scores are selected for further analysis. In step 512, copula models are built for each of the states selected in step 509. In step 515, the copula models are pooled and a forecast is generated using weighted sum. For the operations in steps 512, and 515 the usage of parallel computing may be advisable, for example, using the parallel computing capabilities of a language such as Scala, and computational clustering module 280.

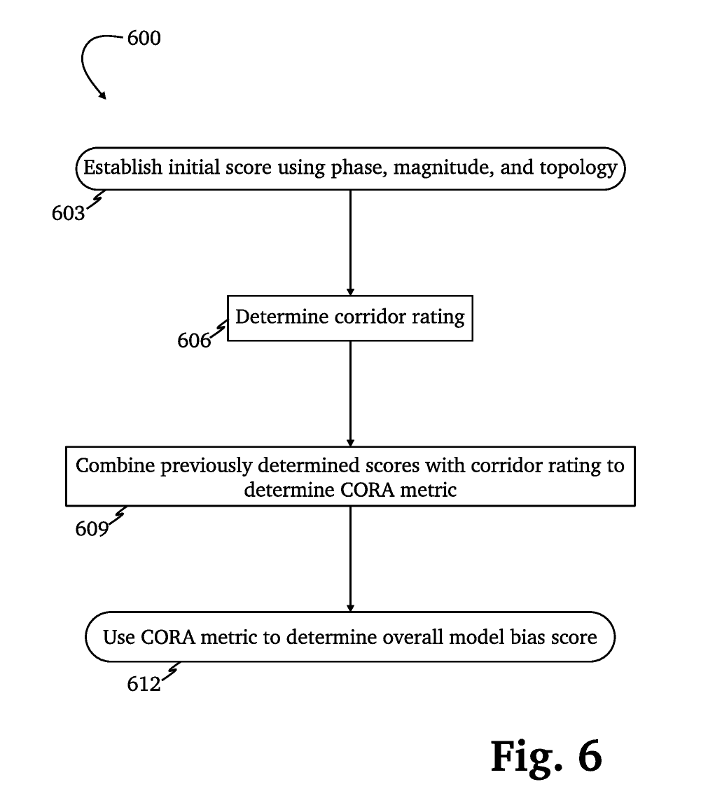

FIG. 6 is a flow diagram illustrating a method 600 for determining a model bias score according to various embodiments of the invention. At step 603, an initial score may be established using just phase, magnitude, and topology criteria for charted data. To determine these criteria, actual data is compared with model output, with the discrepancies evaluated and measured using a technique such as dynamic time warping. In this embodiment, training data may be tested with various models by business operating system 100 to determine which model or models best fit the actual data. The models that are found to be a good fit may be stored in memory for use in later steps. At step 606, a corridor rating is calculated based on fluctuations in the data. Those skilled in the art will appreciate that using this method to calculate a corridor rating also has a smoothing effect to the data. At step 609, the initial score obtained in step 603, and corridor rating obtained in step 606 are used to calculate a Correlation and Analysis (CORA) metric. The CORA metric integrates the initial score obtained in step 603, and corridor rating obtained in step 606, along with a weighting scheme based on expert input, which may be optional, to calculate an overall model bias score in step 612. The model bias scored is used in conjunction with model bias characterization to determine an optimal model to use.

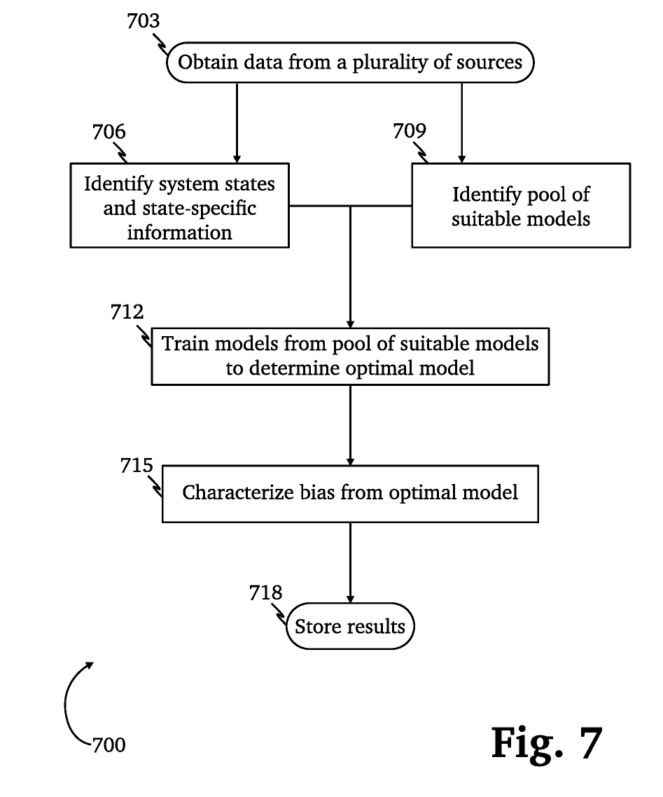

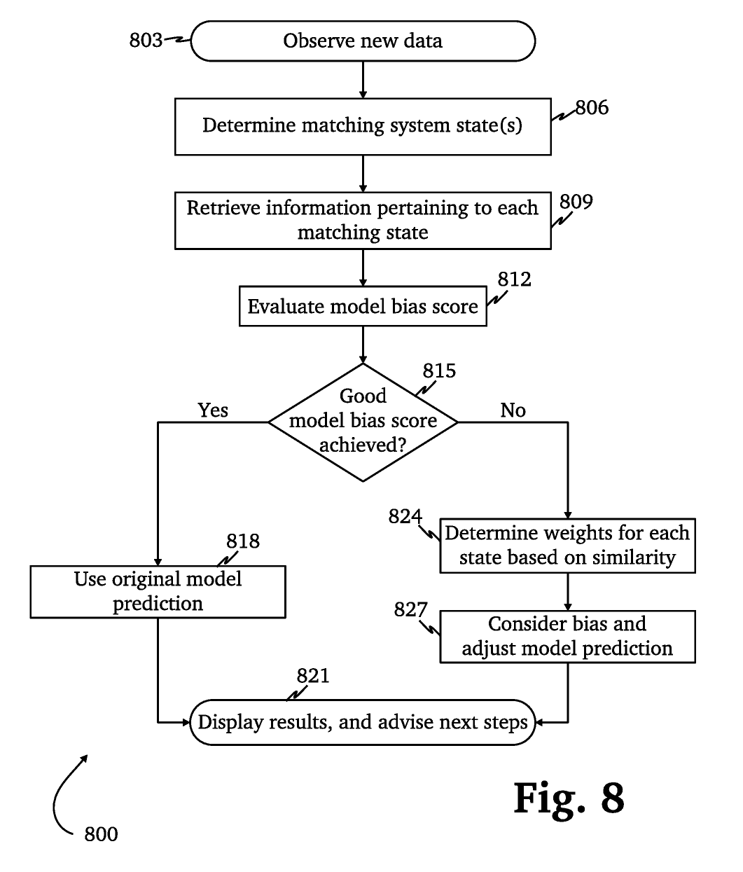

FIG. 7 is a flow diagram illustrating a method 700 for processing previously stored data to be used in similarity testing according to various embodiments of the invention. The flow diagram begins by gathering data from a plurality of sources at step 703. The data may include, but is not limited to, previously gathered and stored data from multidimensional time series data store 120; broker data or market data using connector module 135; corporate news sources; and market analysis and opinions from experts. At step 706, system states and state-specific are identified from the data gathered in step 703. At step 709, which may occur simultaneously with step 706, suitable models stored in memory of the business operating system are selected and pooled. At step 712, training data is used as input for the selected models to determine an optimal model. At step 715, model bias characterization is determined from the optimal model. One method for characterizing model bias is illustrated in FIG. 5. At step 718, results are stored into the data stores of business operation system 100 for future use, one of which is detailed below in FIG. 8. The data that is stored may comprise results from the selected models, optimal model data, model bias, and the like.

FIG. 8 is a flow diagram illustrating a method 800 for systematically determining an appropriate model to use for newly observed data using model bias scoring, and model bias characterization with a business operating system according to various embodiments of the invention. At step 803, new data, such as stock market data, is observed and recorded by business operating system 100. The data undergoes clustering analysis and placed into a state and comparatively matched with previous processed data, as in the process detailed in FIG. 7, at step 806. At step 809, additional information pertaining to the states matched in step 806 are retrieved. At step 812, a model bias score is calculated. This step may be repeated for each of the states matched in step 806. One method for determining the model bias score is illustrated in FIG. 6. At step 815, if a high model bias score is achieved the flow chart goes to step 818, and the selected model may be used without any additional calculations or input. At step 821, results may be formatted to be displayed to the user, and advice regarding advisable next actions may be provided.

On the other hand, if a high model bias score is not achieved at step 815 the flowchart goes to step 824. At step 824 weights are determined for each state based on the similarity between the selected state(s) with the newly observed data. At step 827, additional information and adjustments may be added by the user for consideration in predicting the outcome before finally displaying results and advice at step 821.

It should be understood that the methods illustrated in FIGS. 5 to 8 may be performed by business operation system 100 with minimal user input.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

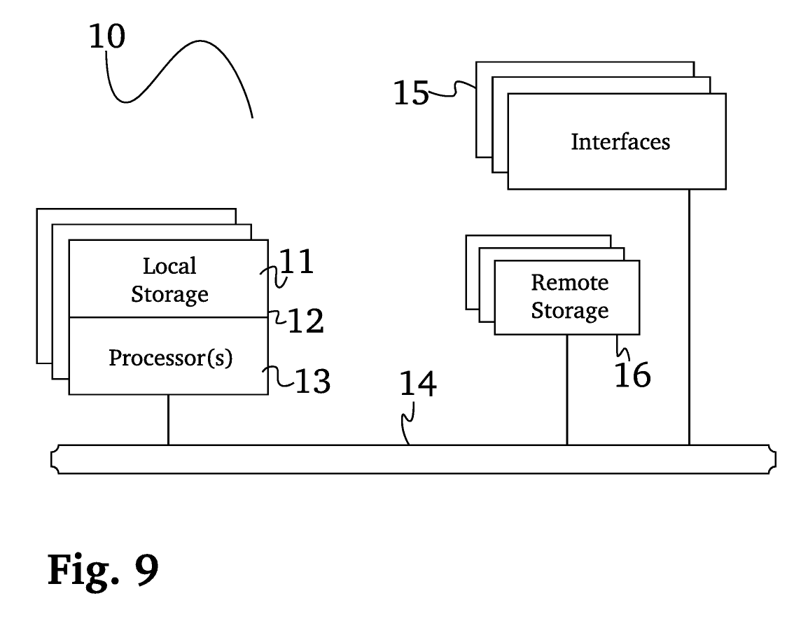

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

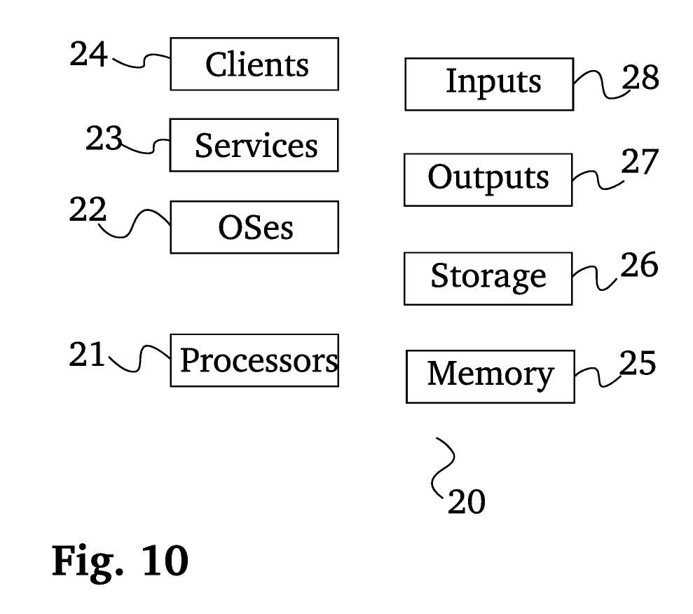

In some aspects, systems may be implemented on a standalone computing system. Referring now to FIG. 10, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE MACOS™ or IOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

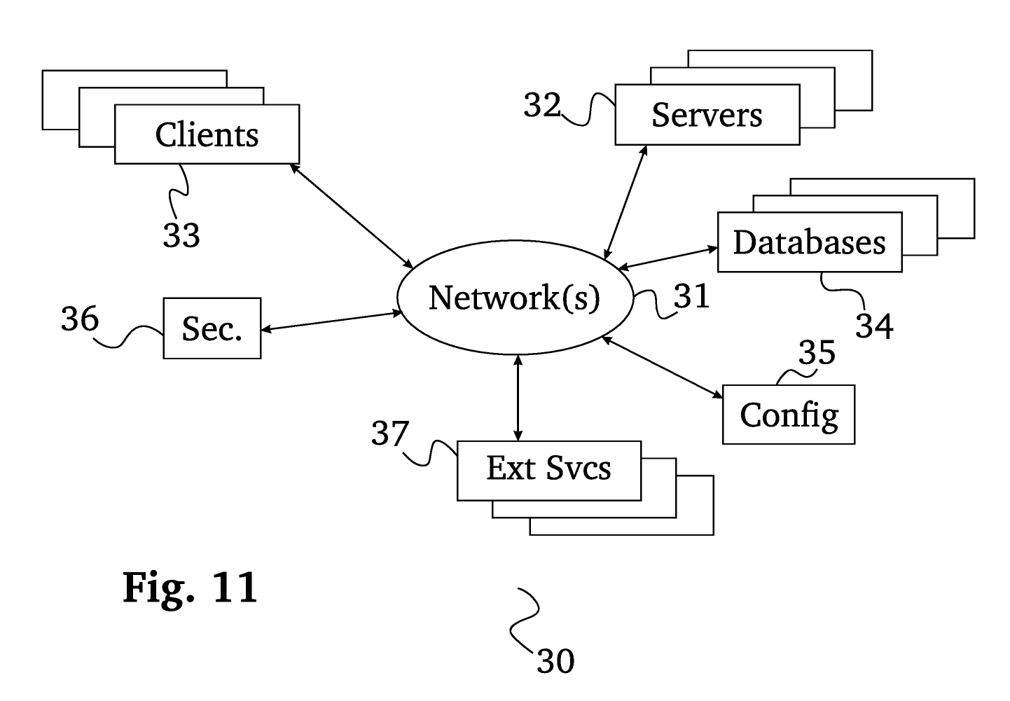

In some aspects, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

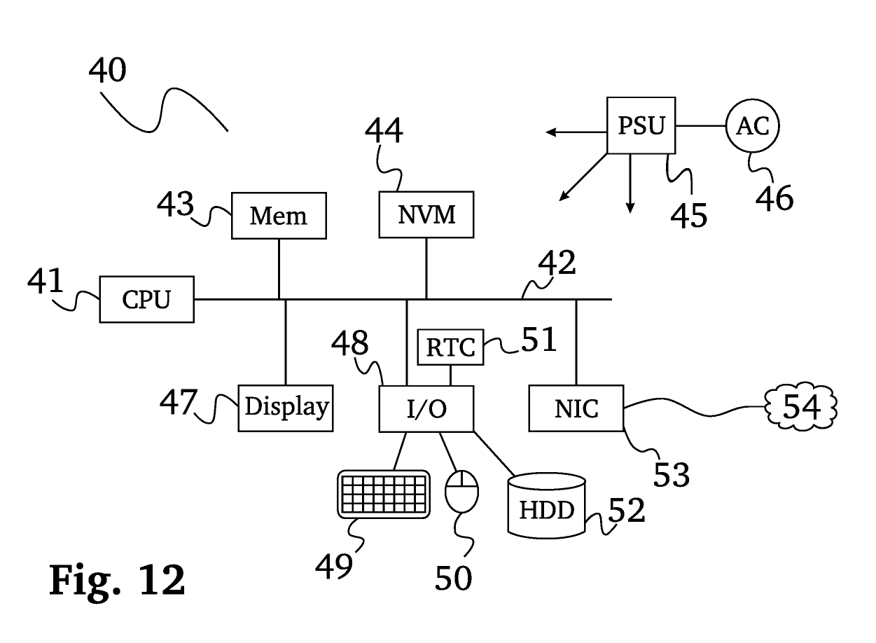

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for automated selection and processing of financial models, comprising:
a time series data retrieval and storage server comprising a memory, a processor, and a plurality of programming instructions stored in the memory thereof and operable on the processor thereof, wherein the programmable instructions, when operating on the processor, cause the processor to:
observe and record a first dataset from a plurality of external sources; and
retrieve a second dataset comprising previously observed, processed, and stored data;
a directed computational graph analysis module comprising a memory, a processor, and a plurality of programming instructions stored in the memory thereof and operable on the processor thereof, wherein the programmable instructions, when operating on the processor, cause the processor to:
retrieve the first and second datasets from the time series data retrieval and storage server; and
comparatively analyze the first dataset against second dataset to determine an optimal model to use for predictive simulation; and
an automated planning service module comprising a memory, a processor, and a plurality of programming instructions stored in the memory thereof and operable on the processor thereof, wherein the programmable instructions, when operating on the processor, cause the processor to:
retrieve analysis results from the directed computational graph analysis module; and
perform predictive simulation using the previous determined optimal model with the first dataset as input.

2. The system of claim 1 wherein at least a portion of the data is analyzed using dynamic time warping to determine the optimal model.

3. The system of claim 1 wherein at least a portion of the data analyzed is the phase, magnitude, and topology.

4. The system of claim 1 wherein at least a portion of the data gathered and processed comprises financial market data.

5. The system of claim 1 wherein at least a portion of the data gathered and processed comprises financial news.

6. The system of claim 1 wherein at least a portion of the data is processed using clustering analysis.

7. The system of claim 1 wherein at least a portion of the data processed is user input during the processing of data.

8. The system of claim 1 wherein analysis results are further processed and analyzed to generate advisable next steps at a user.

9. A method for automated selection and processing of financial, comprising the steps of:
(a) observing and recording a first dataset from a plurality of external sources using a time series data retrieval and storage server;
(b) retrieving a second dataset comprising previously observed, processed, and stored data using the time series data retrieval and storage server;
(c) retrieving the first and second datasets from the time series data retrieval and storage server using a directed computational graph analysis module;
(d) comparatively analyzing the first dataset against second dataset to determine an optimal model to use for predictive simulation using the directed computational graph analysis module;
(e) retrieving analysis results from the directed computational graph analysis module using an automated planning service module; and
(d) performing predictive simulation using the previous determined optimal model with the first dataset as input using the automated planning service module.

10. The method of claim 9, wherein at least a portion of the data is analyzed using dynamic time warping to determine the optimal model.

11. The method of claim 9, wherein at least a portion of the data analyzed is the phase, magnitude, and topology.

12. The method of claim 9, wherein at least a portion of the data gathered and processed comprises financial market data.

13. The method of claim 9, wherein at least a portion of the data gathered and processed comprises financial news.

14. The method of claim 9, wherein at least a portion of the data is processed using clustering analysis.

15. The method of claim 9, wherein at least a portion of the data processed is user input during the processing of data.

16. The method of claim 9, wherein analysis results are further processed and analyzed to generate advisable next steps at a user.
